(19) United States
(12) Patent Application Publication
(10) Pub. No.: US 2010/0074515 A1
(43) Pub. Date: Mar. 25, 2010

(54) Defect Detection and Response

(75) Inventors: Guoheng Zhao, Milpitas, CA (US); George H. Zapalac, JR., Santa Cruz, CA (US); Samuel S.H. Ngai, San Francisco, CA (US); Medhi Vaez-Iravani, Los Gatos, CA (US); Ady Levy, Sunnyvale, CA (US); Vineet Dharmadhikari, San Jose, CA (US)

Correspondence Address: LNG/KLA JOINT CUSTOMER;C/O LUEDEKA, NEELY & GRAHAM, P.C., P.O. BOX 1871, KNOXVILLE, TN, 37901, US

(73) Assignee: KLA-Tencor Corporation, San Jose, CA (US)

(21) Appl. No.: 12/336,704

(22) Filed: Dec. 17, 2008

Related U.S. Application Data
(63) Continuation-in-part of application No. 12/026,539, filed on Feb. 5, 2008.

(51) Int. Cl. G06K 9/00; G02F 1/01

(52) U.S. Cl. 382/149; 250/330

(57) ABSTRACT

To increase inspection throughput, the field of view of an infrared camera can be moved over the sample at a constant velocity. Throughout this moving, a modulation (such as optical or electrical) can be provided to the sample and infrared images can be captured using the infrared camera. Moving the field of view, providing the modulation, and capturing the infrared images can be synchronized. The infrared images can be filtered to generate the time delay lock-in thermography, thereby providing defect identification. In one embodiment, this filtering accounts for the number of pixels of the infrared camera in a scanning direction. For the case of optical modulation, a dark field region can be provided for the field of view throughout the moving, thereby providing an improved signal-to-noise ratio during filtering. Localized defects can be repaired by a laser integrated into the detection system or marked by ink for later repair in the production line.

### FIELD

This application is a continuation-in-part of prior pending U.S. patent application Ser. No. 12/026,539, filed Feb. 5, 2008. This invention relates to the field of photovoltaic cells. More particularly, this invention relates to the inline inspection and repair of photovoltaic films.

### BACKGROUND

During the manufacturing process samples may develop localized electrical defects that cause current leakage. Exemplary samples could include photovoltaic materials (such as 156 mm×156 mm wafers or 2160 mm×2460 mm panels or a continuous web), semiconductor wafers, or printed circuit boards. Electrical defects, such as shunts and localized weak diodes, leak current and therefore can reduce the efficiency of the sample or even jeopardize the functioning of the devices on the sample. Therefore, it is highly desirable to accurately detect the positions of such electrical defects.

Defects have high current density passing through them and therefore heat up to a higher temperature than that of the sample. These temperature changes can be detected in the image from a focal plane array infrared camera. However, the change in temperature at a defect may be five orders of magnitude smaller than the background in the image. Thus, separating the defects from background noise may be challenging.

Lock-in thermography is one known method for locating such defects. In lock-in thermography, the sample is modulated, such as by direct current injection into the sample or by photocurrent generated from illumination of the sample. When the modulation is by illumination, the method is sometimes called illuminated lock-in thermography. Temperature changes caused by heating of the sample from the injected current or photocurrent are modulated at the same frequency. With either form of modulation, multiple frames of infrared images are captured while the sample remains stationary.

Due to the shot noise of background infrared radiation from the sample at room temperature as well as the very small temperature difference between the defects and the rest of the sample, and the limited dynamic range of the infrared imaging sensor, a large number of images of the same field of view are needed to average out the background noise, thereby improving the signal to noise ratio. Although the captured images are taken from the identical spatial location, they are a function of time as the temperature of the sample oscillates at the frequency of modulation. In a typical embodiment, the images are filtered by multiplying each image by a weighting factor that varies sinusoidally in time at the same frequency as the modulation or “lock-in” frequency. In general, the improvement of signal to noise ratio is proportional to the square root of the total number of frames.

Conventional lock-in thermography requires that the sample remains stationary while the infrared camera acquires the necessary number of images for lock-in averaging. If the size of the sample is greater than the field of view of the camera, the sample (or the infrared camera) needs to move to a completely different location to capture a new set of infrared images after one set of images is captured for one location on the sample. Unfortunately, this stop-go time as well as the settling time (which includes repositioning with its attendant velocity ramp up and ramp down) takes a large portion of the total inspection time, especially for very large samples that can be greater than two meters square in size, thereby undesirably reducing throughput. This overhead in conventional lock-in thermography becomes a significant limiting factor of inspection throughput.

Therefore, a need arises for a technique of detecting defects on a sample that increases inspection throughput compared to conventional lock-in thermography while maintaining its accuracy. The defects that are found can also be repaired with the same instrument, such as by laser isolation.

### SUMMARY

Conventional lock-in thermography techniques require that the sample remains stationary while the infrared camera acquires the necessary number of images for lock-in integration. After one set of images is acquired, the sample is replaced or repositioned to capture infrared images for a different sample or location. This stationary and repositioning time significantly reduces inspection throughput.

To increase inspection throughput, a method of performing time delay lock-in thermography on a sample is provided. In this method, the field of view of an infrared camera can be moved over the sample at a constant velocity. Throughout this moving, a modulation (such as optical or electrical) can be provided to the sample and infrared images can be captured using the infrared camera. Moving the field of view, providing the modulation, and capturing the infrared images can be synchronized. The infrared images can be filtered to generate the time delay lock-in thermography image, thereby providing defect identification. In one embodiment, this filtering can include sinusoidal weighting at the lock-in frequency that takes into account the number of pixels of the infrared camera in a scanning direction.

Advantageously, this time delay lock-in thermography can be used on various types of samples, such as semiconductor wafers, photovoltaic wafers, large panels of photovoltaic material, continuous webs of photovoltaic material, and printed circuit boards. Further, the moving can be done using any efficient moving components, such as a scanning stage, bi-directional linear stages in a gantry system, a gantry bridge, a conveyor, and/or at least one roller.

In one embodiment, the field of view can be located within a dark field region throughout the moving, thereby providing an improved signal-to-noise ratio during filtering. This dark field technique can also be used in what would otherwise be standard illuminated lock-in thermography. In this method, the sample is illuminated outside the camera field of view. Infrared images can be captured using the infrared camera, wherein providing the modulation and capturing the infrared images are synchronized. The infrared images can be filtered to generate the time-averaged image, thereby providing defect identification. Advantageously, the sample can be rotated or moved linearly to reposition the field of view and the dark field region on another section of the sample. At this point, the steps of providing the modulation, capturing the infrared images, and filtering the infrared images can be repeated.

This dark field technique can be used with various types of samples, such as semiconductor wafers, photovoltaic wafers, photovoltaic panels, continuous webs of deposited photovoltaic material, and printed circuit boards. Positioning and rotating can include using a scanning stage, bi-directional linear stages in a gantry system, a gantry bridge, a conveyor, a rotating chuck, and/or at least one roller.

A system for performing the time delay lock-in thermography can include an infrared camera for capturing images of the sample. Scanning components can move the field of view of the infrared camera over the sample at a constant velocity. Modulation components can provide a modulation to the sample when moving the field of view. A clock source can synchronize the capturing of images, the moving of the field of view, and the source of the modulation. An image processor can receive the captured images and generate the time delay lock-in thermography image to provide defect detection. In one embodiment, a light shield is used to shadow the field of view from the source of illumination for illumination lock-in thermography.

A system for performing dark field illuminated lock-in thermography can include positioning components for positioning the field of view of the infrared camera over the sample. Optical modulation components can provide an optical modulation to the sample after positioning the field of view. A light directing component can provide a dark field region for the field of view. A clock source can synchronize the image acquisition to the modulation. An image processor can receive the captured images and generate the time delay illuminated lock-in thermography image to detect defects on the sample. The light directing component can include a light shield or a light pipe.

A system for performing defect repair by laser isolation or other means may be integrated into the detection system of the present invention. This system could include one or more repair lasers disposed immediately downstream of the infrared camera and activated automatically by the detection of localized defects or hot spots. For example, a 532 nanometer Q-switched laser could be guided by a dual axis galvanometer scanner through a telecentric lens to cut an electrically isolating trench around the defect, thereby isolating the shunt from the rest of the surface. Alternately, the position of the defect could be marked by deposition of an ink or other substance for repair at a later stage of production.

### BRIEF DESCRIPTION OF THE FIGURES

FIG. 1 illustrates an exemplary time delay Illuminated lock-in thermography system including a dark field illumination.

FIG. 2A illustrates an exemplary acquisition of frames of infrared images using conventional lock-in thermography.

FIG. 2B illustrates an exemplary acquisition of frames of infrared images using time delay lock-in thermography.

FIG. 2C illustrates an exemplary sample modulation relative to a plurality of frame triggers.

FIG. 3 illustrates an exemplary inspection system including a single infrared camera that can move in both x and y directions using a gantry system.

FIG. 4 illustrates an exemplary inspection system including multiple infrared cameras that can move in one direction using a gantry system.

FIG. 5 illustrates an exemplary inspection system including multiple infrared cameras that capture images of samples moving on a conveyor.

FIG. 6 illustrates an exemplary dark field illumination for the field of view that can further minimize background noise.

FIG. 7 illustrates an exemplary dark field of view experimental result, wherein an expanded laser beam modulates current for an illuminated area of the sample.

FIG. 8 illustrates an illumination system that can include a light pipe, which ensures that the light generated by a light source is efficiently relayed to a surface of the sample.

FIGS. 9A and 9B illustrate the rotation of a sample to reposition the dark field region for the field of view beneath an exemplary light pipe configuration that can be particularly efficient for smaller samples in an Illuminated lock-in thermography system.

FIG. 10 illustrates an exemplary dark field Illuminated lock-in thermography system that uses the light pipe configuration of FIGS. 9A and 9B.

FIGS. 11 and 12 illustrate other exemplary dark field Illuminated lock-in thermography configurations using rotational and linear movements, respectively.

FIG. 13 illustrates the dark field Illuminated lock-in thermography configuration of FIG. 11 in a system that includes both rotational and linear movements.

FIG. 14 illustrates a dark field Illuminated lock-in thermography in a system including at least one roller for moving a web sample.

FIG. 15 illustrates aspects of a solar cell that facilitate forward biasing or reverse biasing of the solar cell during inspection.

FIG. 16 is a side view of a combination inspection and repair tool according to an embodiment of the present invention.

FIG. 17 is a top view of a combination inspection and repair tool according to an embodiment of the present invention.

### DETAILED DESCRIPTION

Conventional lock-in thermography systems require that the sample remains stationary while the infrared camera acquires the necessary number of images for lock-in integration. After one set of images are captured for one location on the sample, the sample is repositioned to capture infrared images for a completely different location. This stationary and repositioning time significantly reduces inspection throughput.

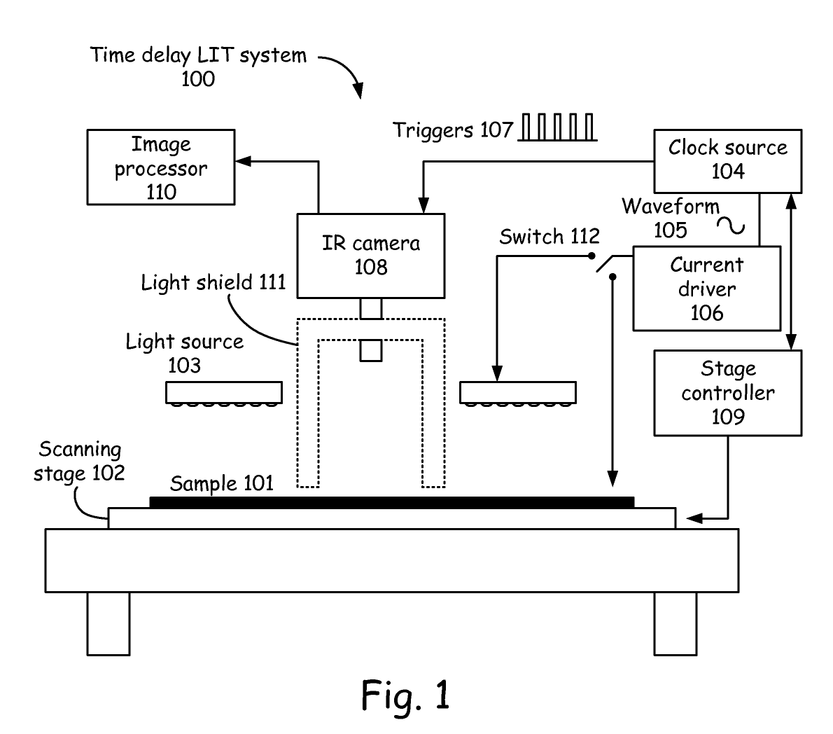

FIG. 1 illustrates an exemplary time delay lock-in thermography system 100 that can significantly increase inspection throughput. In this embodiment, a sample 101 is positioned on an x-y scanning stage 102. Applying a modulation to the sample can be performed optically (such as by using a modulated illuminating light source) or electrically (such as by directly applying a current modulation to the sample). In one embodiment, a current driver 106 can be selectively connected to a light source 103 or directly connected to sample 101 using a switch 112. In other embodiments, system 100 can include the components to provide only one type of modulation, such as current driver 106 and light source 103 or only current driver 106, and eliminate switch 112.

Light source 103 can be constructed using multiple light emitting diode modules. However, in other embodiments, light source 103 can be implemented using a standard white light source modulated by a chopper, lasers that are directly modulated, or Q-switch lasers.

A clock source 104 can generate a waveform 105, which is provided to current driver 106. This waveform is converted to a current that, as described above, can drive light source 103 or is directly connected to sample 101. Clock source 104 can also generate triggers 107 that activate an infrared camera 108 to capture infrared images, which in turn are provided to an image processor 110. Clock source 104 can be connected to a stage controller 109, which outputs a positioning encoder pulse to scanning stage 102. In this configuration, as described in further detail below, clock source 104 can advantageously ensure that the speed of sample motion is properly synchronized to the image acquisition frame rate and the modulation rate. In other embodiments, the encoder signal of the stage controller can be used as the clock signal to trigger a function generator for providing modulation to the sample, and also for triggering the infrared camera for image acquisition.

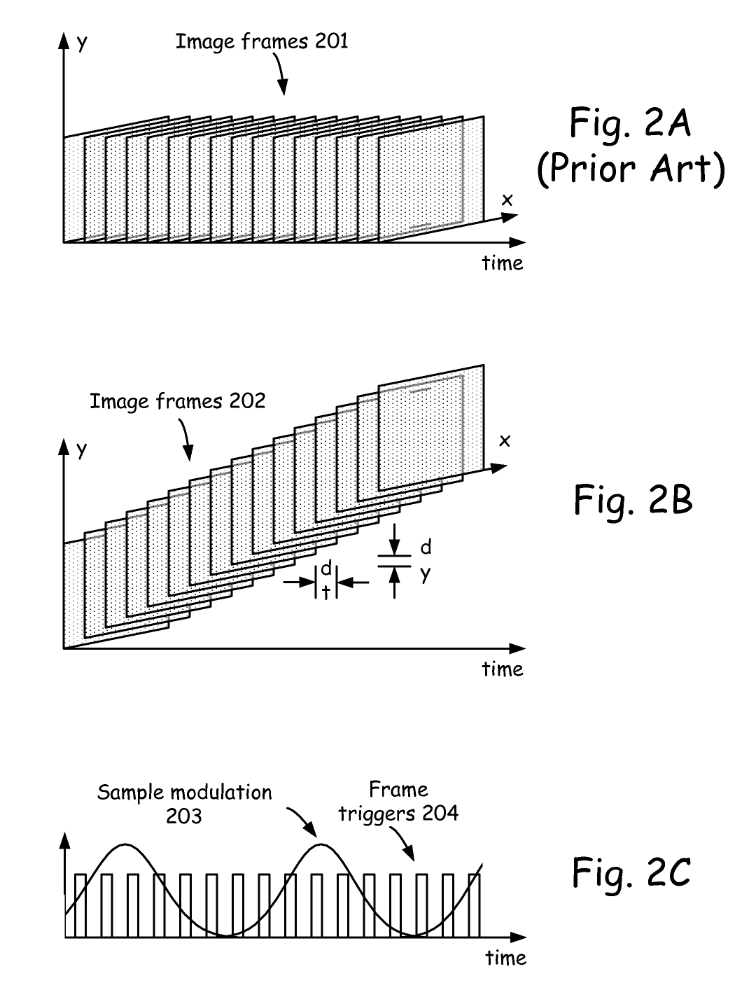

FIG. 2A illustrates an exemplary acquisition of frames 201 of infrared images using conventional lock-in thermography. As described above, to acquire frames 201, the sample is modulated with a periodic signal, such as a sinusoidal function, while the sample remains stationary. Frames 201 are then processed by applying a Fourier filter in the time domain at the frequency of modulation.

In one embodiment, the discrete sine and cosine transforms are defined as follows.

$$\begin{matrix}{S}_{m , n} = \frac{1}{{N}_{F}} {\sum }_{i = 1}^{{N}_{F}} {I}_{m , n}^{i} sin ( 2 π \frac{{f}_{1}}{{f}_{2}} ( i - 1 ) ) & Equation 1 \\ {C}_{m , n} = \frac{1}{{N}_{F}} {\sum }_{i = 1}^{{N}_{F}} {I}_{m , n}^{i} cos ( 2 π \frac{{f}_{1}}{{f}_{2}} ( i - 1 ) ) & Equation 2\end{matrix}$$

Where I_{m,n}¹ is the pixel value of the (m,n)th pixel of the ith frame, m=1, 2, . . . Nₓ, n=1, 2 . . . N_{y}, i=1, 2, 3 . . . , f₁ is the frequency of modulation, f₂ is the frame rate (preferably an even integer multiple of f₁), Nₓ and N_{y} are the number of pixels in one frame in the x and y directions, and NF is the total number of frames (such as an integer multiple of the number of modulation cycles).

Note that certain samples may respond differently to different phases of modulation. However, notably, the sine and cosine transforms can be combined to generate an amplitude independent of phase. Specifically, using the values for S_{m,n} and C_{m,n} as computed by Equations 1 and 2, the amplitude A and phase image φ are given by:

A=\sqrt{S²+C²} Equation 3

$$φ = {tan}^{- 1} \frac{S}{C} \qquad Equation 4$$

In contrast, FIG. 2B illustrates an exemplary acquisition of frames 202 of infrared images using time delay lock-in thermography. As described above in reference to FIG. 1, unlike conventional lock-in thermography, multiple image frames are acquired in time delay lock-in thermography while the sample moves at a constant speed (thus, the imaged locations as measured in a y direction change over time). Advantageously, the speed of motion (dy/dt) can be synchronized to the frame rate of the image acquisition.

In one embodiment, the sample can move by a distance of one pixel within the time duration of one frame. Thus, in one embodiment, the total number of frames for time delay lock-in thermography is the same as the number of pixels of the field of view of the infrared camera in the scan direction. Note that image capture can begin with the field of view only slightly overlapping the sample (such as by one pixel or less) to ensure that even the edges of the sample are in fact imaged multiple times.

In other embodiments, the distance that a sample moves between two consecutive frames can be integer multiples, such as 1, 2, 3 . . . pixels, which allows higher inspection speed at a fixed frame rate. The integer multiple approach provides lower sensitivity because the total number of frames for lock-in thermography is reduced by a factor equal to the number of pixels moved. In yet another embodiment, the distance that the sample moves between two consecutive frames can be less than 1 pixel (such as generically 1/N pixel: ⅕ pixel, ¼ pixel, ⅓ pixel, ½ pixel, etc.), which allows higher inspection accuracy, but results in slower inspection speed. In one embodiment, a predetermined number of frames can be designated for capture during each modulation cycle (such as at least 4), thereby determining inspection accuracy as well as the allowed inspection speed.

In accordance with any embodiment of time delay lock-in thermography, as the sample is modulated at a fixed frequency, each imaging pixel of the sample is imaged multiple times as the sample continuously moves across the field of view of the infrared camera. Therefore, an image for each imaging pixel is read out multiple times by a line of the pixels of the infrared imaging sensor, which can form part of the infrared camera. The captured images in a time delay lock-in thermography image are given by the following sine and cosine transforms, which together provide Fourier filtering.

$$\begin{matrix}{S}_{m , i} = \frac{1}{{N}_{Y}} {\sum }_{n = 1}^{{N}_{Y}} {I}_{m , n}^{( i + n - 1 )} sin [ 2 π ( i - 1 + n - 1 ) \frac{{f}_{1}}{{f}_{2}} ] & Equation 5 \\ {C}_{m , i} = \frac{1}{{N}_{Y}} {\sum }_{n = 1}^{{N}_{Y}} {I}_{m , n}^{( i + n - 1 )} cos [ 2 π ( i - 1 + n - 1 ) \frac{{f}_{1}}{{f}_{2}} ] & Equation 6\end{matrix}$$

Where I_{m,n}⁽ⁱ⁺ⁿ⁻¹⁾ is the pixel value of the (m,n)th pixel of the (i+n−1)th frame of the infrared images, i=1, 2 . . . , m=1, 2, . . . Nₓ, n=1, 2, . . . N_{y}, f₁ is the frequency of modulation, and f₂ is the frame rate. Preferably f₂ is an even integer (≧4) multiple of f₁. Nₓ and N_{y} are the number of pixels in one frame in the x and y directions. Note that the index n appears in both the subscripts of pixel index and the superscript of frame index of I_{m,n}⁽ⁱ⁺ⁿ⁻¹⁾, which defines the tracking each pixel of a specific spatial position as it moves across the field of view of the infrared camera. The speed V of the moving sample is given by:

V=Pf₂ Equation 7

where P is the pixel size on sample. As described above, the speed V of the moving sample, the sample modulation, and the frame triggers can be synchronized to ensure a desired frame capture. FIG. 2C illustrates an exemplary sample modulation 203 relative to a plurality of frame triggers 204. In other embodiments, the speed of the moving sample can be generalized to be greater than or less than 1 pixel per frame interval (time duration between two consecutive frames); equation 7 is then written as:

V=kPf₂ Equation 8

In one embodiment, k can be an integer of greater than 1, for example, k=2, 3, 4, . . . . In this case, the pixels of each frame can be binned in the scan (y) direction by the number of pixels equal to k. The effective number of pixels in the y direction is reduced by a factor of k, and equations 5 and 6 still apply as long as the image is down-sampled to the effective number of pixels. In another embodiment, k can be less than 1. For example, the sample may move half a pixel per frame interval when k=½, or one third of a pixel when k=⅓. In this case, the effective number of pixels per frame in the scan direction is increased by a factor of 1/k. The effective image may be reconstructed to larger size by re-sampling of the image through interpolation methods such as nearest neighborhood, linear, spline, or cubic interpolations. Equations 5 and 6 still apply as long as the image size in the scan direction is re-sampled to the effective number of pixels increased by the factor of 1/k. Note that the phase and amplitude can then be computed using equations 3 and 4.

Note that the sensor of the infrared camera can have a rectangular format, with rectangular sensor elements (wherein a square is considered as a special case of a rectangle). In one embodiment, the sample moves at a constant speed in a direction parallel to one of the edges of the rectangular sensor. Note that P, the imaging pixel size on the sample, can be computed by the size of the sensor element along the scan direction divided by the magnification of the imaging lens.

In one embodiment of image processor 110, a technique called time delayed integration can synchronize pixel shifting with movement of the sample. Time delayed integration is described in detail in U.S. Pat. No. RE 37,740, entitled “Method and apparatus for optical inspection of substrates”, which issued on Jun. 11, 2002. However, in this reference, time delayed integration captures only one instance of each imaging pixel (such as a line scan imaging mode). Notably, time delayed integration can be modified to keep track of multiple captured images for each imaging pixel as the field of view moves across the sample, thereby allowing time delayed integration to be used in the context of time delay lock-in thermography. This tracking can be performed by a computer-implemented software program installed in image processor 110.

Moreover, also in image processor 110, a single frequency Fourier filter (or matched filter, at the same frequency of modulation) in the time domain can be applied to the captured image, over a window of the multiple frames. As described above, each frame can be shifted by a predetermined number of pixels (1, 2, 3 . . . ) in the scan direction when applying the Fourier filter.

In Equations 5 and 6, each y-column i in the final image is a weighted sum from multiple frames of images, where image n contributes to this sum the column i+n−1.

By using a continuous scan of a sample, time delay lock-in thermography can advantageously eliminate the undesirable stop-go action of conventional lock-in thermography inspection systems, thereby significantly reducing inspection overhead time. Therefore, high throughput inspection in a production environment can be implemented. Notably, by varying the number of pixels moved, time delay lock-in thermography can advantageously optimize a desired speed/sensitivity balance.

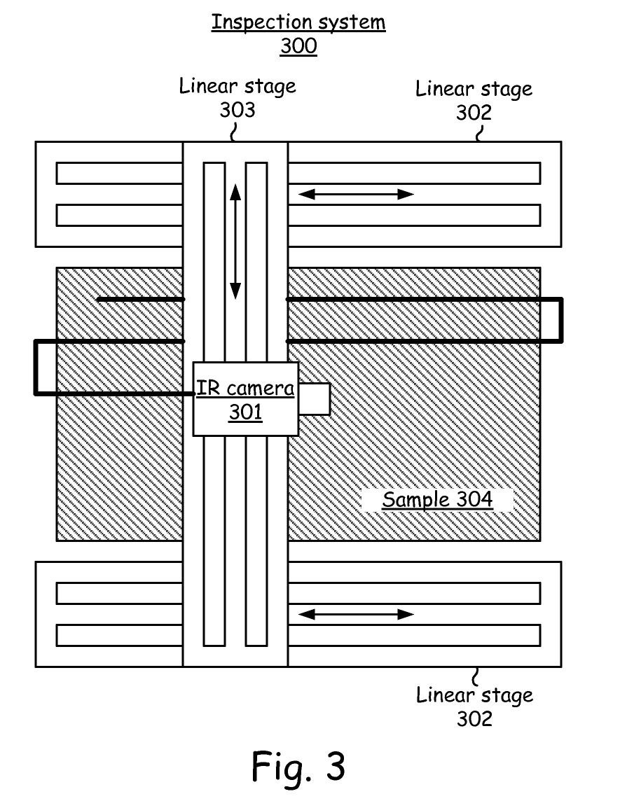

Note that when the images of the sample are captured, the sample could be moving with respect to the infrared camera (such as using scanning stage 102 of FIG. 1) or the infrared camera could be moving with respect to the sample. For example, FIG. 3 illustrates an exemplary inspection system 300 including a single infrared camera 301 that can move in both x and y directions by a gantry system, which includes linear stages 302 that allow camera movement in an x direction and a linear stage 303 that allows camera movement in a y direction. As shown in FIG. 3, alternating horizontal and vertical movements result in a serpentine scan of a sample 304.

In this embodiment, sample 304 is a single sample (such as a thin film, large-scale solar panel formed on a glass substrate). Note that in other embodiments using this gantry system, sample 304 could be replaced with multiple samples.

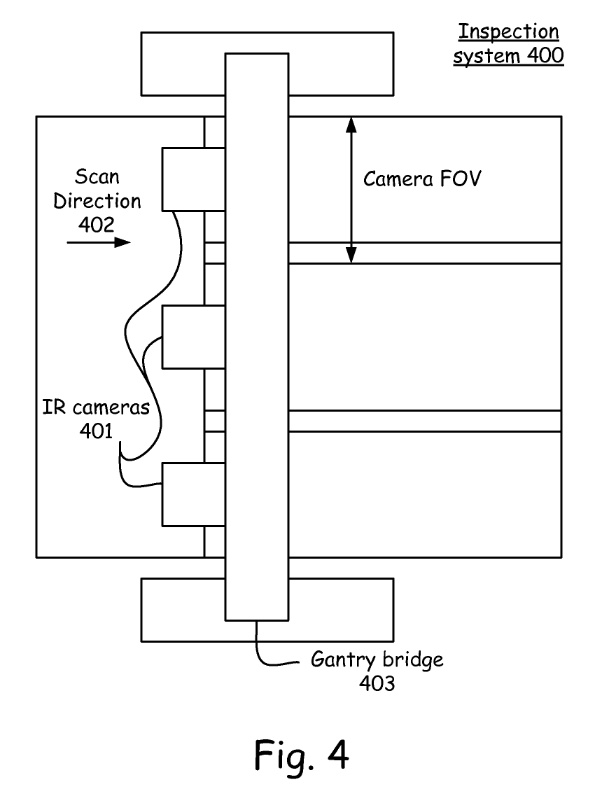

Multiple parallel infrared cameras can further improve inspection speed. For example, FIG. 4 illustrates an exemplary inspection system 400 including 3 infrared cameras 401, although other embodiments can include fewer or more infrared cameras (note that other system components, such as those components shown in FIG. 1, are not shown for simplicity). In this embodiment, infrared cameras 401 can provide a single pass scan in a direction 402 using a gantry bridge 403.

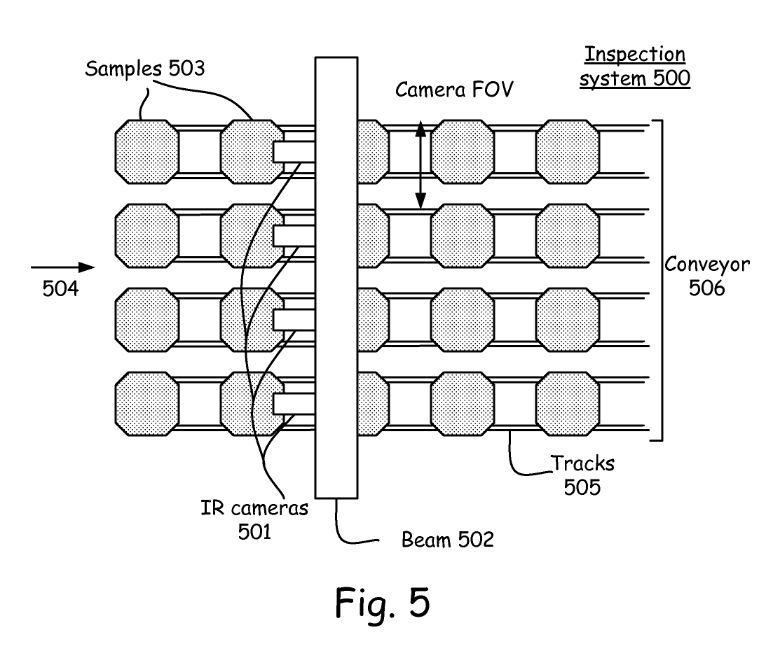

FIG. 5 illustrates an exemplary inspection system 500 including 4 infrared cameras 501, although other embodiments can include fewer or more infrared cameras. In this embodiment, infrared cameras 501 can be positioned on a stationary beam 502, whereas samples 503 can move in a direction 504 using tracks 505, which form part of a conveyor 506.

In one embodiment, an infrared camera can be implemented using a medium wave infrared camera having a sensor resolution of 320×256 pixels. The inspection system including this infrared camera can include the following operating characteristics: a frame rate of 433 frames per second, an imaging resolution of 0.5 mm, a sample speed of 216 mm/s, and an inspection speed of 276 cm²/s.

Referring back to the time delay lock-in thermography system 100, the use of light source 103 to provide current modulation can result in some heat generation. Specifically in the case of solar cells, some portion of the illumination light is converted to heat due to the limited efficiency of solar cells to convert light power to electric power. The heat generated by the illumination can increase the background infrared emission, which results in greater background noise and thus lower detection sensitivity. Notably, because the excessive heat due to illumination is generated at the same frequency as the defect signal modulation, the emissivity difference between different materials (such as metal grid lines vs. silicon) shows in the lock-in thermography image as a non-uniform background noise that may not be easily removed, thereby further reducing the defect sensitivity.

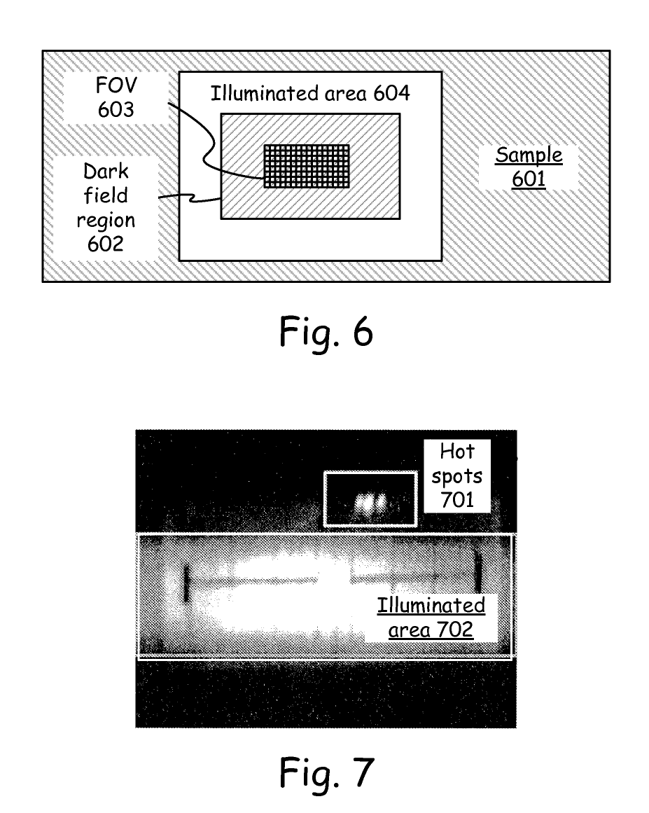

Therefore, in one embodiment, system 100 can use a light shield 111 to create a dark field region for the field of view of the infrared camera. In one embodiment, light shield 111 can be positioned above sample 101 by 2-4 mm, or any other distance that limits illumination of the sample. For example, FIG. 6 illustrates a dark field region 602 that could be provided by light shield 111 for protecting an field of view 603 on a sample 601. In this case, an illuminated area 604 occurs outside dark field region 602. Notably, although illuminated area 604 is limited to be outside of field of view 603, the photocurrent generated by such illumination can quickly flow into the area of field of view 603.

Therefore, the sample heating due to excessive photon energy is constrained to be outside of field of view 603. As a result, this indirect illumination advantageously minimizes the background noise inside field of view 603. However, of interest, despite using dark field region 602 for field of view 603, defects are still visible to the infrared camera.

For example, FIG. 7 illustrates an exemplary experimental result, wherein an expanded laser beam modulates current for an illuminated area 702 of the sample. Defects that leak current appear as hot spots 701. As shown in FIG. 7, (1) the background heating is higher where the light directly illuminates the sample, i.e. inside illuminated area 702, (2) the background heating is much lower outside illuminated area 702, and (3) the defects still appear as hot spots 701 even though they are outside illumination area 702 because current flows freely across the sample.

Referring back to FIG. 1, a predetermined area outside the field of view of infrared camera 108 (such as a band of illumination substantially parallel to the border of the field of view) can be illuminated by light source 103 (such as an array of light emitting diodes) as defined by light shield 111. Notably, light shield 111 can advantageously reduce the background heating of the field of view, thereby increasing the signal to noise ratio of the defect in the captured images. Better signal to noise ratio results in higher throughput (i.e. shorter integration times at a given sensitivity) and/or higher sensitivity.

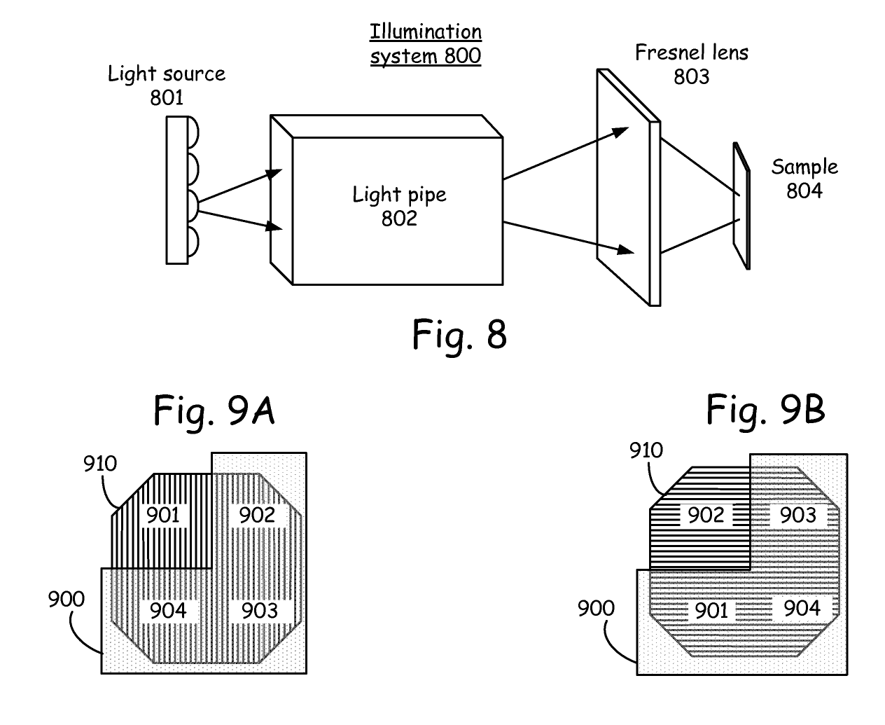

In one embodiment shown in FIG. 8, an illumination system 800 can include a light pipe 802 that can ensure that the light generated by a light source 801 is efficiently relayed to a surface of sample 804 without a light shield. Note that light pipes can be particularly effective for analyzing smaller samples, such as small-scale solar cells (for example, 6″×6″) and semiconductor wafers, to limit light dispersion to only the samples for which images are being collected. In one embodiment, to further limit light dispersion, an optional Fresnel lens 803 can be used to focus the light from light pipe 802 onto sample 804.

Light pipe 802 can be implemented using a solid block of glass that guides the light by total internal reflection of the sidewalls of light pipe 802. In another embodiment, light pipe 802 can be implemented using a hollow tube with mirror surfaces inside. In any implementation of light pipe 802, a clearly defined illumination area (such as rectangular) is projected into sample 804.

Advantageously, a light pipe can be configured to cover large or small areas of a sample. In any configuration, a light pipe can provide a relatively sharply defined border for the dark field region as well as the illuminated area. For example, a light pipe could sharply define the borders of illuminated area 604 of FIG. 6 (and thus also the border of dark field region 602). In contrast, the outside border of illuminated area 604, if created by a light shield, would typically be diffused, whereas the inside border would be relatively sharply defined (assuming that the light shield is close enough to the sample).

FIGS. 9A and 9B illustrate an exemplary configuration for a light pipe configuration that can be particularly efficient for smaller samples, such as semiconductor wafers or solar cells, in what would otherwise be a conventional lock-in thermography system. In this configuration, a sample 910 can be divided into (i.e. characterized as having) 4 quadrants, such as 901, 902, 903, and 904, and the shape of a light pipe 900 is substantially matched to three quadrants of sample 910. In FIG. 9A, quadrants 902, 903, and 904 are illuminated by light pipe 900, whereas quadrant 901, which is in a dark field region, can be imaged by an infrared camera (not shown for simplicity). Another quadrant can be imaged by rotating sample 910 relative to light pipe 900. For example, from FIG. 9A to FIG. 9B, sample 910 is rotated counter clockwise by 90 degrees relative to light pipe 900. Thus, quadrants 901, 903, and 904 are illuminated by light pipe 900, whereas quadrant 902, which is in dark field region, can be imaged by the infrared camera. Therefore, all quadrants 901, 902, 903, and 904 can be inspected by rotating sample 910 three times.

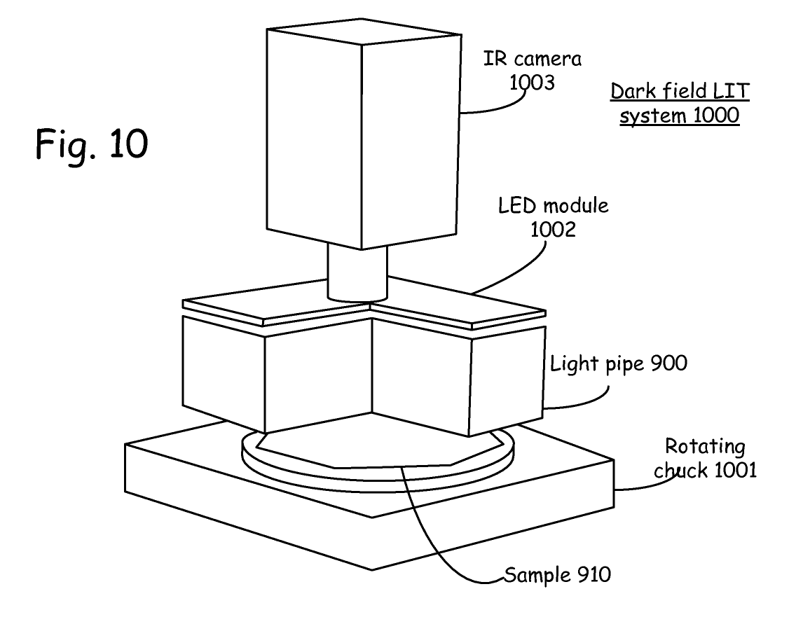

FIG. 10 illustrates an exemplary dark field lock-in thermography system 1000 including light pipe 900 and sample 910. In system 1000, sample 910 is positioned on a rotating chuck 1001 that can perform the desired rotations (such as 90 degree rotations). Light pipe 900 can direct the light from light emitting diode module 1002 onto sample 910. An infrared camera 1003 can capture images from the dark field quadrant of sample 910. In this embodiment, infrared camera 1003 can capture multiple shots of the dark field quadrant over time as sample 910 is current modulated by the light directed by light pipe 900. After a desired number of images have been captured by infrared camera 1003, rotating chuck 1001 can be rotated to expose another quadrant of sample 910.

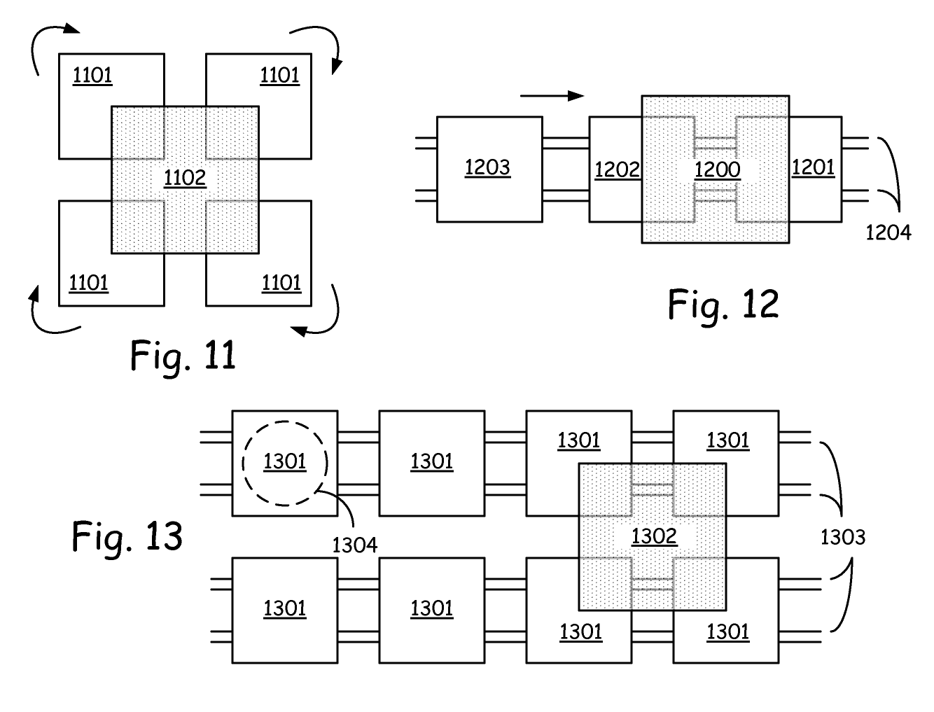

In other embodiments, a multi-sample dark field lock-in thermography system can be implemented. For example, FIG. 11 illustrates an exemplary configuration including four samples 1101. Block 1102 delineates the border of a dark field region. In this case, after an infrared camera (not shown for simplicity) simultaneously captures the desired number of dark field images from samples 1101, then each of samples 1101 can be rotated (such as clockwise by 90 degrees as shown by the arrows using four chucks, not shown for simplicity) to begin capturing images from different quadrants of samples 1101.

Note that other embodiments can include different divisions of the sample. For example, FIG. 12 illustrates an exemplary configuration including a dark field region 1200 and three samples 1201, 1202, and 1203 on a conveyor belt 1204. In this case, the camera first images the left side of sample 1201 and the right side of sample 1202 within dark field region 1200. The conveyor belt 1204 next moves one sample width to the right (i.e. in a linear motion, as indicated by the arrow), and the camera images the left side of sample 1202 and the right side of sample 1203 within dark field region 1200. In another embodiment, the conveyor belt moves continuously and time delayed lock-in thermography is used to process the image as described earlier. In this embodiment, the width of the field of view must be less than the width of the sample so that part of the sample is always illuminated as the sample passes beneath the dark field region. For example, for a rectangular focal plane array with 320×256 pixels, the infrared camera would be oriented so that the width of the cell normal to the direction of motion is covered by 320 pixels, and the width of the cell parallel to the direction of motion is covered by 256 pixels.

In one embodiment, both rotational and linear movements can be included in a dark field lock-in thermography system. For example, FIG. 13 illustrates a dark field lock-in thermography system configuration 1300 including a plurality of samples 1301 that can be positioned on rotating chucks 1304 (one shown for simplicity), which in turn can be secured to a conveyor 1303. In the configuration shown in FIG. 13, four samples 1301 can be simultaneously imaged as described in reference to FIG. 11. After the desired images are captured from all quadrants (using rotating chucks 1304), then the next four samples 1301 can be moved into position (using conveyor 1303) relative to dark field region 1302 for the next round of image capture.

Notably, as shown above, providing the dark field region for the field of view can be included in both time delay lock-in thermography and conventional lock-in thermography systems to advantageously reduce background noise when optical modulation is used. Moreover, this dark field lock-in thermography can be used for numerous types of samples, such as semiconductor wafers, solar cells, solar panels, printed circuit boards, and continuous webs.

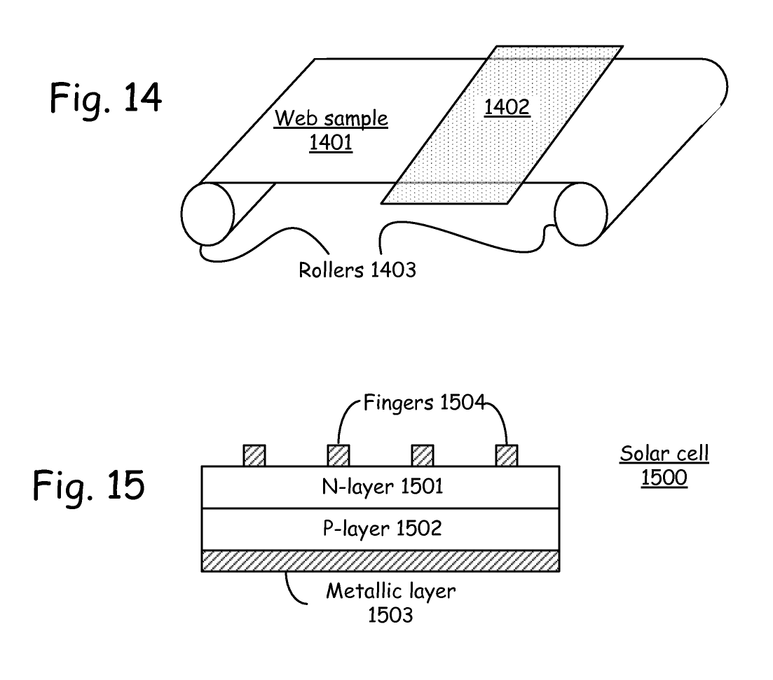

For example, FIG. 14 illustrates an exemplary dark field lock-in thermography system 1400 in which a web sample 1401 can be advanced using rollers 1403. An exemplary web sample is a stainless steel ribbon (such as approximately 14 inches wide) on which photovoltaic material can be deposited. After the desired images are captured in a dark field region 1402, another portion of web sample 1401 can be positioned under dark field region 1402 using rollers 1403 and then imaged. In one embodiment, dark field lock-in thermography system 1400 could include other rollers for positioning web sample 1401 for subsequent processing (such as physical cutting of web sample 1401).

In another embodiment, dark field lock-in thermography system 1400 can be easily converted into a time delay, dark field lock-in thermography system. That is, rollers 1403 can be used to provide the constant velocity used in a time delay lock-in thermography system. Note that other embodiments can include fewer or more rollers to provide the advancement of the web sample. Typically, a system implementation using a web sample includes at least one roller.

Although illustrative embodiments of the invention have been described in detail herein with reference to the accompanying figures, it is to be understood that the invention is not limited to those precise embodiments. They are not intended to be exhaustive or to limit the invention to the precise forms disclosed. As such, many modifications and variations will be apparent to practitioners skilled in this art.

For example, as described above for time delay lock-in thermography, when the images of the sample are captured, the sample could be moving with respect to the infrared camera or the infrared camera could be moving with respect to the sample. As used herein, moving an field of view of the infrared camera over the sample is meant to describe either movement. Notably, either movement can provide the same captured images.

Further, note that when time delay lock-in thermography is combined with a dark field region for the inspection of multiple samples (such as samples 503 of FIG. 5), then the modulation of any one sample will vary over time (because the percentage of the sample exposed to the light field (versus dark field) varies over time). However, this modulation variation can be compensated for by the appropriate programming of the image processor (such as image processor 110 of FIG. 1).

Yet further, referring back to FIG. 15, two different electrical modulations can be performed on samples: forward bias electrical modulation and reverse bias electrical modulation. For example, in the case solar cell 1500, a reverse bias could be applied by connecting the positive terminal to N-layer 1501 (such as using metallic fingers 1504 on the top surface of solar cell 1500) and the negative terminal to P-layer 1502 (such as using a metallic layer 1503 on the back surface of solar cell 1500). In contrast, a forward bias could be applied by connecting the negative terminal to N-layer 1501 and the positive terminal to P-layer 1502. Each electrical modulation could be used to detect a different type of defect. For example, in one embodiment, the forward bias current modulation can be used to detect defects that behave more like a diode but have a low open circuit voltage.

Note that although the directed illumination configurations described herein provide a border of illumination around the field of view, other embodiments could provide different illumination shapes. That is, because current flows freely through the sample, another illumination configuration could include a plurality (≧2) of illuminated blocks distributed around the field of view that still allow modulation of the field of view.

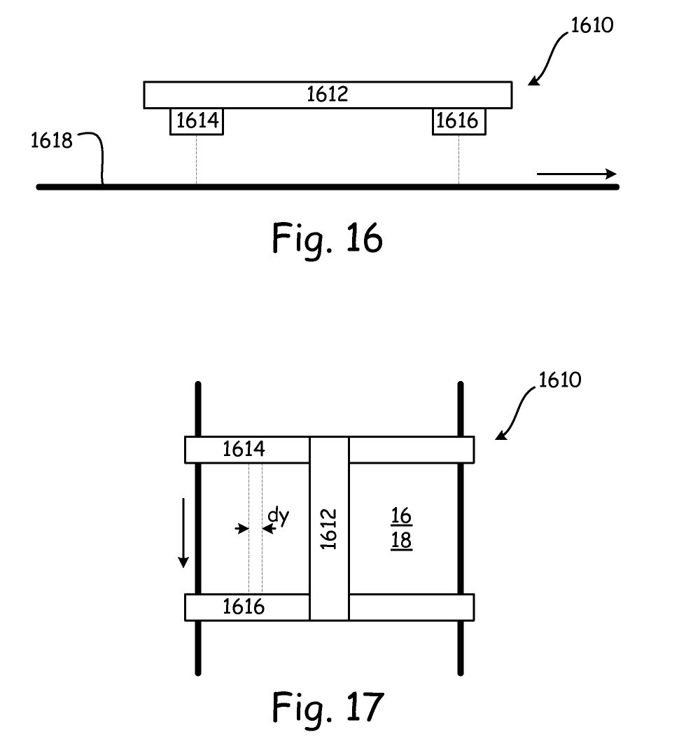

With reference now to FIGS. 16 and 17, additional aspects of the apparatus 1600 according to an alternate embodiment of the present invention are described. In one embodiment, the inspection is performed by a linear array of detectors 1614 that is arranged along the y direction, perpendicular to the direction of the motion of the web 1618, which is in the x direction. Each detector element in the array 14 defines a track of the web 1618, having a width of dy. For example, a web 1618 that is fourteen inches wide with 356 detectors would be divided into 356 tracks each of about one millimeter in width dy. If a shunt were detected in a given track, then that track would be repaired at the appropriate time—as calibrated to the traveling velocity of the web 1618 in the x direction—within a few centimeters downstream of the detector array 1614. The repair instrument 1616 in some embodiments is similarly segmented in a manner that generally corresponds to the track positions as defined by the detector 1614 and described above. The detector 1614 and the repair instrument 1616 are, in some embodiments, connected to a common frame 1612, and are thus disposed within the same tool 1610.

The inspection and repair operations can, in alternate embodiments, be performed either before or after the final conducting film is applied to the photovoltaic junction. If the inspection by the detection module 1614 is performed before the final contact layer is applied, then it could be performed, for example, by photoemission as described in U.S. patent application Ser. No. 11/690,809 filed 2007.03.24, the disclosure of which is incorporated by reference herein as if laid out in its entirety. The inspection by the detection module 1614 could also be performed by a non-contact measurement of the open circuit voltage under intense illumination by visible light, in which shunted regions will have a reduced voltage. A voltage measurement would not require a vacuum provided by a frictionless air bearing as discussed in application Ser. No. 11/690,809.

In various embodiments, the shunt is repaired by the repair module 1616 by printing, spraying, or otherwise applying or creating an insulating material on the defective track at the appropriate time as determined by the web velocity. If the inspection is performed after the final contact is applied to the web, then in one embodiment the detection module 1614 illuminates the web 18 upstream of a linear charge coupled device array (also a part of the detection module 1614) over a region of great enough area to generate “hot spots” in the material, where the shunted current locally heats the shunted region. The charge coupled device array detects infrared radiation (in the wavelength of about three to five microns) and the surface is repaired by the repair module 1616 such as by laser cutting the transparent conductive oxide as described in U.S. patent application Ser. No. 11/278,158 filed 2006 Mar. 31, the disclosure of which is incorporated by reference herein as if laid out in its entirety.

Alternately, instead of laser cutting near the position of inspection, an ink could be printed on the shunted region to tag it for repair at a position further downstream by another tool. For example, this ink could be a reflective mark to guide a subsequent laser repair, or it could be a chemical agent that diffuses into the oxide and increases the resistivity under anneal.

There are several advantages to the various embodiments of the present invention. For example, only the material in the vicinity of the shunt is affected by the repair, because the repair is accomplished in close proximity a precise detection of the shunt. The floor space of the tool is more compact (if repair is performed by the same tool) and requires significantly less floor space than an electrochemical bath with subsequent rinsing and drying steps. A detailed map of the shunt distribution can be electronically provided to diagnose process excursions such as, for example, in the uniformity of film deposition. Further, algorithms may be implemented to select which shunts are repaired.

The various embodiments of the present invention share several novel features, including (1) the division of the moving web into tracks as defined by the detectors and the repairing tool, (2) the integration of detection and repair (or tagging for repair) into a single tool to minimize errors in defect coordinates during repair and to reduce floor space, (3) voltage detection to locate shunts before final contact is applied, coupled with the application or formation of an insulating material to electrically isolate the shunt, (4) illuminating the web upstream of a linear charge coupled device to create hot spots for infrared detection.

Such a tool can be used on web-based fabrication of thin film CIGS or a-Si photovoltaic material, or on a production line for cadmium telluride or crystalline silicon photovoltaic material. This invention could significantly improve solar cell efficiency by removing shunts and diagnosing process excursions using defect maps of shunts. Shunting sometimes flags process excursions that reduce cell efficiency by other ways in addition to shunting, such as by recombination of carriers at impurity sites or by a low open circuit voltage due to a poorly defined p-n junction.

The various embodiments of the present invention find and repair shunts on a moving production line of photovoltaic material, and act to reduce the distance that a web of photovoltaic material moves between the detection of a shunt and the repair operation of the shunt, by integrating the detection and repair operations within a single tool. This reduces errors between the determination of the position in which a shunt is disposed, and relocating that position at a later point in time when the repair of the shunt is performed. This also reduces the floor space required for the tool.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A system for performing time delay lock-in thermography on a sample, the system comprising:
an infrared camera for capturing images of the sample,
scanning components for moving a field of view of the infrared camera over the sample at a constant velocity,
modulation components for providing a modulation to the sample when moving the field of view,
a clock source for synchronizing the capturing of images, the moving of the field of view, and the providing of the modulation,
an image processor for receiving the captured images and generating a time delay lock-in thermography image to provide detection of a defect, and
instrumentation to at least one of repair the defect, and mark a position of the defect for later repair.

2. The system of claim 1, wherein the instrumentation repairs the defect with a laser that electrically isolates the defect.

3. The system of claim 1, further including one of a light shield and a light pipe for providing a dark field region for the field of view.

4. The system of claim 1, wherein the image processor includes filters that implement two equations:
$$\begin{matrix}{S}_{m , i} = \frac{1}{{N}_{Y}} {\sum }_{n = 1}^{{N}_{Y}} {I}_{m , n}^{( i + n - 1 )} sin [ 2 π ( i - 1 + n - 1 ) \frac{{f}_{1}}{{f}_{2}} ] \\ {C}_{m , i} = \frac{1}{{N}_{Y}} {\sum }_{n = 1}^{{N}_{Y}} {I}_{m , n}^{( i + n - 1 )} cos [ 2 π ( i - 1 + n - 1 ) \frac{{f}_{1}}{{f}_{2}} ]\end{matrix}$$
where i=1, 2 . . . , m=1, 2, . . . Nₓ, n=1, 2 . . . N_{y}, f₁ is the frequency of modulation, f₂ is the frame rate, Nₓ and N_{y} are numbers of pixels in one frame in x and y directions.

5. A system for performing dark field, lock-in thermography on a sample, the system comprising:
an infrared camera for capturing images of the sample,
positioning components for positioning a field of view of the infrared camera over the sample,
optical modulation components for providing an optical modulation to the sample after positioning the field of view,
a light directing component for providing a dark field region for the field of view,
a clock source for synchronizing the capturing of images and the providing of the modulation,
an image processor for receiving the captured images and generating a time delay lock-in thermography image to detect a defect on the sample, and
instrumentation to at least one of repair the defect, and mark a position of the defect for later repair.

6. The system of claim 5, wherein the instrumentation repairs the defect with a laser that electrically isolates the defect.

7. A tool for detecting and taking action on a defect in a moving web of photovoltaic material without stopping the movement of the web, the tool comprising:
a detection module for detecting the defect in the web as it is moving, the detection module comprising a linear array of sensors disposed across the web of photovoltaic material perpendicular to the movement of the web, where each sensor in the linear array inspects an incremental portion of a width of the web,
an action module for taking a predetermined action on the defect in the web as it is moving, the action module comprising a linear array of actors disposed across the web of photovoltaic material perpendicular to the movement of the web, where each actor in the linear array acts upon an associated one of the incremental portions of the width of the web,
a common frame to which both the detection module is mounted and the action module is mounted, where the detection module is disposed at a known distance from and in an upstream position to the action module relative to the movement of the web, and
a controller for determining a position of the defect as detected by the detection module, at least one of receiving and detecting a speed of the moving web, and for instructing the action module to take action on the defect at an appropriate point in time when the defect is disposed within an action range of the action module, based at least in part upon the speed of the moving web and the known distance between the detection module and the action module.

8. The tool of claim 7, wherein the detection module detects the defect using a voltage detection method.

9. The tool of claim 7, wherein the detection module detects the defect using a hot spot detection method.

10. The tool of claim 7, wherein the action module repairs the defect.

11. The tool of claim 7, wherein the action module repairs the defect by laser isolating the defect.

12. The tool of claim 7, wherein the action module repairs the defect by forming a nonconductive surface on top of the defect.

13. The tool of claim 7, wherein the action module physically marks the defect without repairing the defect.

14. A method of performing time delay lock-in thermography on a sample, the method comprising the steps of:
moving a field of view of an infrared camera over the sample, the moving being at a constant velocity,
providing a modulation to the sample throughout the moving,
capturing infrared images using the infrared camera throughout the moving, wherein moving the field of view, providing the modulation, and capturing the infrared images are synchronized,
filtering the infrared images to generate a time delay lock-in thermography image, thereby providing defect identification, and
at least one of repairing a defect and marking a position of the defect for later repair.

15. The method of claim 14, wherein the modulation is one of optical and electrical.

16. The method of claim 14, wherein the sample is one of a semiconductor wafer, a solar cell, a solar panel, a continuous web, and a printed circuit board.

17. The method of claim 14, wherein filtering includes performing two equations:
$$\begin{matrix}{S}_{m , i} = \frac{1}{{N}_{Y}} {\sum }_{n = 1}^{{N}_{Y}} {I}_{m , n}^{( i + n - 1 )} sin [ 2 π ( i - 1 + n - 1 ) \frac{{f}_{1}}{{f}_{2}} ] \\ {C}_{m , i} = \frac{1}{{N}_{Y}} {\sum }_{n = 1}^{{N}_{Y}} {I}_{m , n}^{( i + n - 1 )} cos [ 2 π ( i - 1 + n - 1 ) \frac{{f}_{1}}{{f}_{2}} ]\end{matrix}$$
where i=1, 2 . . . , m=1, 2, . . . Nₓ, n=1, 2 . . . N_{y}, f₁ is the frequency of modulation, f₂ is the frame rate, Nₓ and N_{y} are numbers of pixels in one frame in x and y directions.

18. The method of claim 14, further including providing a dark field illumination for the field of view throughout the moving.

19. The method of claim 14, wherein moving includes using at least one of a scanning stage, bi-directional linear stages in a gantry system, a gantry bridge, a conveyor, and at least one roller.

20. The method of claim 14, wherein repairing the defect is accomplished with a laser that electrically isolates the defect.
